(19) United States
(12) Patent Application Publication
(10) Pub. No.: US 2009/0320377 A1
(43) Pub. Date: Dec. 31, 2009

(54) Casement Window

(76) Inventor: Mike Fulton, Canton, GA (US)

Correspondence Address: KAPLAN WARD & PATEL LLC, CUMBERLAND CENTER II, 3100 CUMBERLAND BLVD , SUITE 1400, ATLANTA, GA, 30339, US

(21) Appl. No.: 12/163,547

(22) Filed: Jun. 27, 2008

(51) Int. Cl. E06B 3/34; E05D 7/00

(52) U.S. Cl. 49/399; 49/381; 49/506

(57) ABSTRACT

A window rotatable about a pivot point to selectively cover and uncover an opening of a structure, and having at least one operable sash selectively movable within a channel to partially uncover the opening without requiring rotation of the window about the pivot point. The window is preferably configured to rotate inwardly about a top edge whereby the window is protected within the structure when the opening is uncovered by rotation of the window about the pivot point.

### TECHNICAL FIELD

The present disclosure relates generally to windows, and more particularly to casement windows.

### BACKGROUND OF THE INVENTION

Windows of varying types are available in the home construction and remodeling industries to provide light and/or ventilation for structures of many types. Such windows may provide ventilation by uncovering the entire window opening in which they are installed, such as in a casement window that opens on one side or an awning window that opens outwardly at is the bottom. Both of these windows are typically operable via a hand-operated crank. Alternatively, windows may have one or more operable sash(es) adapted to move vertically or horizontally may provide ventilation by uncovering a fraction of the window opening.

Both traditional casement windows and windows with one or more operable sash(es) suffer from disadvantages. Specifically, casement windows suffer from an inability to open the window a substantial amount without requiring clearance for an arc of travel of the casement, and further involve slow, clumsy, and inconvenient crank operation. Thus, opening such windows, especially in an emergency, can be difficult. Furthermore, casement windows are arranged to open outwardly, whereby the casement, particularly the edges thereof, is exposed to sun, rain, insects, and other environmental hazards. For example, a conventional side hinged casement window may suffer from water damage if left open during a rain shower, or the window may be damaged by wind if left open in a storm. Additionally, since casement windows open outwardly, if a screen is provided, it must be mounted on the interior of the window, where it is exposed to damage caused by projectiles or the like, especially in a home with small children.

Windows with operable sashes suffer from an inability to uncover the window opening completely, since the sashes merely slide along tracks of the window, a space equal to the size of one sash will always be blocked. Additionally, windows with sashes, even tilting sashes, are notoriously difficult to clean, because access to the exterior portion of the windows is restricted. Furthermore, installation and/or removal of exterior screens is difficult from inside a structure due to such restricted access to the exterior of the window. As a further disadvantage, escaping from a window having sashes is difficult due to the inability to completely uncover the window opening.

As such, it is clear that there is an unmet need for a window which provides opening alternatives to consumers whereby the window may fully or partially uncover the window opening without exposing the window to environmental hazards, and that allows for easy operation, cleaning, and maintenance, including installation and removal of screens.

### BRIEF SUMMARY OF THE INVENTION

Briefly described, in a preferred embodiment, the window of is the present disclosure overcomes the above-mentioned disadvantages and meets the recognized need for such a device by providing a window having a frame including at least one operable sash, the frame being hingedly operable with an opening of a structure.

More specifically, the frame of the window is preferably formed generally as a rectangle having top, bottom, left, and right edges, and preferably includes two operable sashes arranged in vertical tracks, whereby each sash may slide vertically within an associated track, preferably with assistance provided by a spring, piston, or other device, as known by those ordinarily skilled in the art. The frame preferably further includes a hinge disposed on the top edge whereby the frame may pivot about the hinge. The hinge is preferably arranged such that the frame may swing inwardly from the opening of the structure. A lift assist device is preferably further included, such as in the form of a pneumatic piston and cylinder arrangement engaged with an area of the frame proximate at least one of the left side edge and the right side edge. The lift assist device preferably substantially maintains the frame in an open position, whereby the frame may conveniently and easily be opened and maintained in the open position via simply lifting the bottom edge of the frame inwardly. Such hinged opening preferably allows the entire window opening of the structure to be uncovered. Alternatively, the sashes may be arranged such that the window is completely closed, wherein the entire opening of the structure is covered, or such that the window is partially open, wherein a portion of the top and/or the bottom of the opening of the structure is uncovered.

Accordingly, one feature and advantage of the window of the present disclosure is its ability to provide a greater number of alternative window configurations, whereby some, all, or none of an opening of a structure may be uncovered, as desired.

Another feature and advantage of the window of the present disclosure is its ability to swing inwardly, whereby opening the window may not interfere with a screen disposed on an exterior of the window, and whereby an exterior of the window may easily be cleaned.

Yet another feature and advantage of the window of the present disclosure is its ability to position the frame proximate a ceiling of a room when opened inwardly via the hinge, whereby accidental contact with the window frame is avoided when the opening is completely uncovered, and whereby exposure of the frame and sashes of the window may be avoided when the opening is completely uncovered.

These and other features and advantages of the present invention will become more apparent to those ordinarily skilled in the art after reading the following Detailed Description and Claims in light of the accompanying drawing Figures.

### BRIEF DESCRIPTION OF THE DRAWINGS

Accordingly, the present disclosure will be understood best through consideration of, and with reference to, the following drawing Figures, viewed in conjunction with the Detailed Description referring thereto, in which like reference numbers throughout the various Figures designate like structure, and in which:

FIG. 1 is a perspective view of a window according to the present disclosure;

FIG. 2 is a detail view of the window of FIG. 1;

FIG. 3 is a side view of the window of FIG. 1 in an open position;

FIG. 4 is a side view of the window of FIG. 1 in a closed position; and

FIG. 5 is a cross-sectional view of the window of FIG. 1.

It is to be noted that the drawings presented are intended solely for the purpose of illustration and that they are, therefore, neither desired nor intended to limit the invention to any or all of the exact details of construction shown, except insofar as they may be deemed essential to the claimed invention.

### DETAILED DESCRIPTION

In describing preferred embodiment of the window of the present invention illustrated in the Figures, specific terminology is employed for the sake of clarity. The claimed invention, however, is not intended to be limited to the specific terminology so selected, and it is to be understood that each specific element includes all technical equivalents that operate in a similar manner to accomplish a similar purpose.

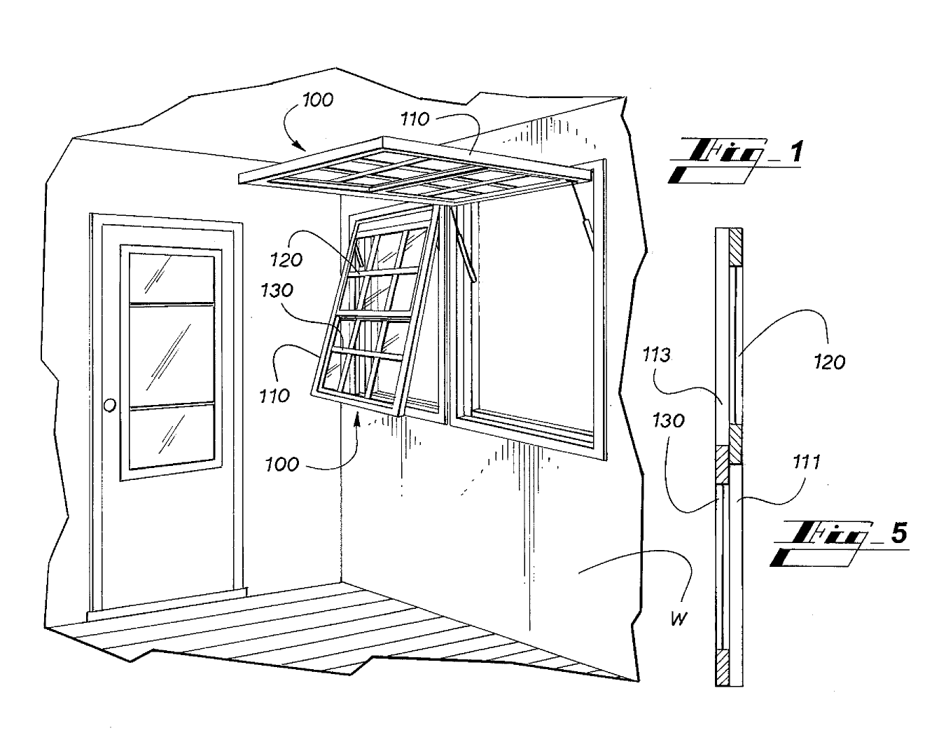

As shown in FIGS. 1-5, window 100 preferably comprises frame 110, and upper sash 120 and lower sash 130 carried thereby. Frame 110 preferably includes first outer track 111 in which outer (upper) sash 120 may slide vertically and second inner track 113 in which inner (lower) sash 130 may slide vertically. Thus, frame 110, upper sash 120, and lower sash 130 preferably operate in a conventional fashion for a double-hung window, wherein upper sash 120 and/or lower sash 130 may be independently moved vertically within a respective one of tracks 111 and 113. As will be understood by those ordinarily skilled in the art, additional features, such as locking, tilting, divided light, insulating, low-E, UV filtering, or the like, or combinations thereof, may be included with each of upper sash 120 and lower sash 130. Furthermore, one or more of frame 110, upper sash 120, and lower sash 130 may be formed of wood, metal, such as steel, aluminum, or the like, plastic such as vinyl or the like, composites, combinations thereof, or other suitable material.

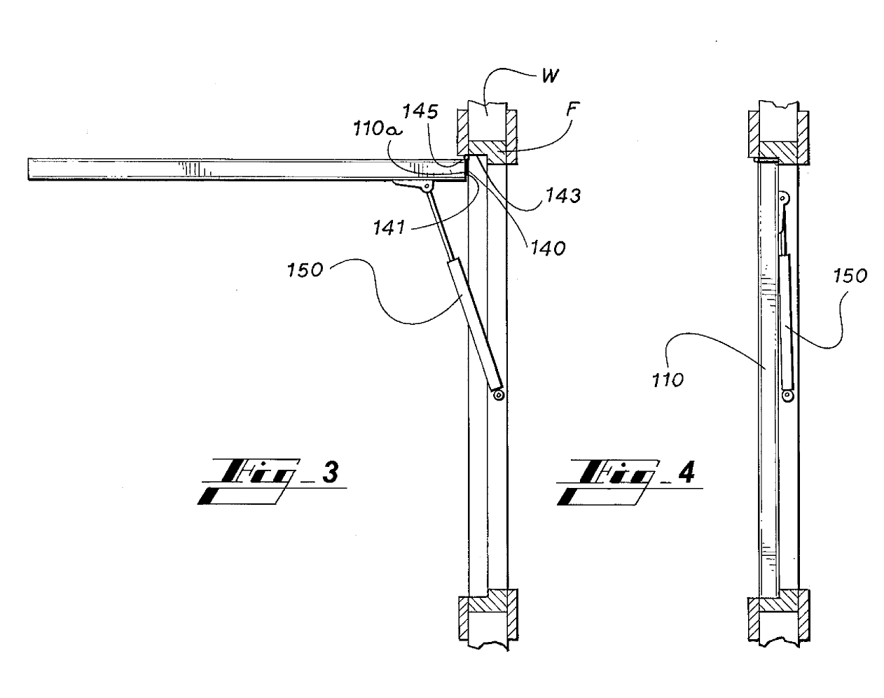

Window 100 preferably further includes hinge 140 disposed along top edge 110a of frame 110, whereby window 100 may be engaged with frame F of wall W. As will be understood by those ordinarily skilled in the art, window 100 may rotate about hinge 140, whereby opening O of wall W may be completely uncovered. Thus, hinge 140 preferably operates as a pivot point, whereby window 100 may be selectively disposed in the open position illustrated in FIG. 3 and the closed position illustrated in FIG. 4. As illustrated in FIG. 3, hinge 140 is preferably formed as a piano-style hinge having first leaf 141 connected to frame 110 and operable with central pin 145 and second leaf 143 connected to frame F of wall W and operable with central pin 145. As will be understood by those ordinarily skilled in the art, hinge 140 may alternatively be replace by pins, a track, another style of hinge, or other structure adapted to enable pivoting of frame 110 between the open position and the closed position.

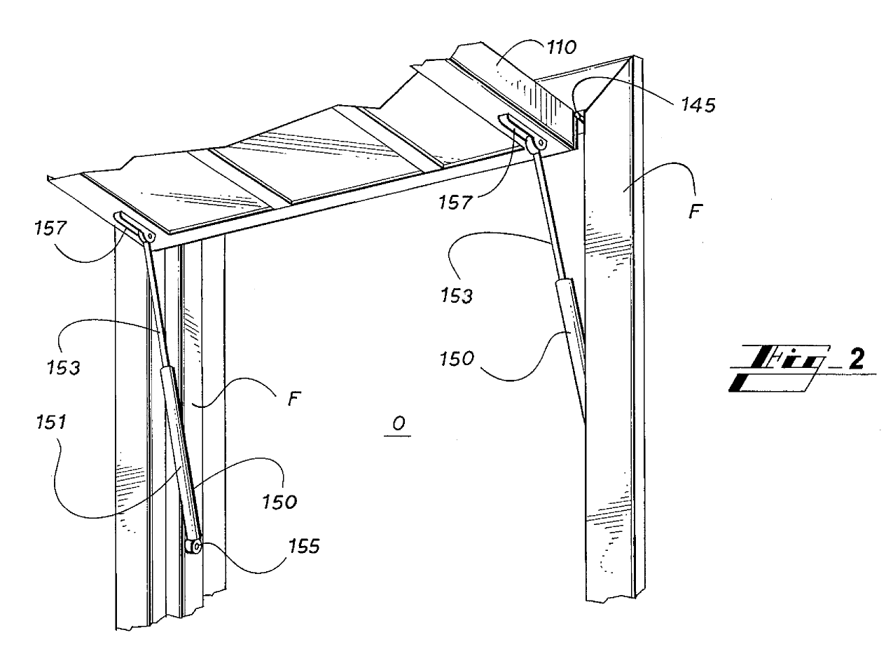

Lift assist device 150 is preferably operable to assist in opening window 100 as window 100 swings about hinge 140, and is preferably operable to substantially retain window 100 in the open position. For such purpose, lift assist device 150 preferably includes pneumatic cylinder 151 and pneumatic piston 153 operable therewith and biased axially away from cylinder 151. As best shown in FIG. 2, a proximal end of pneumatic cylinder 151 is preferably rotatably operable with frame F via bracket 155 while a distal end of pneumatic piston 153 is preferably rotatably operable with frame 110 via bracket 157. Thus, as window 100 is rotated about hinge 140 from the closed position to the open position, lift assist device 150 preferably extends to apply a lifting force to frame 110.

Additionally, and as shown in FIG. 4, when window 100 is in is the closed position, brackets 155 and 157 are preferably disposed approximately in vertical registration, and approximately linearly arranged with hinge 140. Thus, in the closed position, lift assist device 150 preferably applies relatively little torque to frame 110 for an amount of extension force of lift assist device 150, whereby window 100 is not opened thereby and does not require restraint to remain in the closed position. Nonetheless, as window 100 swings about hinge 140, an amount of torque applied to frame 110 by the same amount of extension force of lift assist device 150 preferably increases due to mis-alignment of lift assist device 150 and hinge 140. Particularly, the extension force of lift assist device 150 and the location of brackets 155 and 157 are preferably selected to allow lift assist device to apply a torque to frame 110 at least equal to an opposing torque applied thereto by gravity in the open position, that nonetheless may easily be manually overcome by a user.

Optionally, lift assist device 150 may be configured to automatically open window 100, such as upon activation of a switch. For example, lift assist device may be formed as an electrically-driven piston, or the like, such that a user may a not be required to apply any force to frame 110 during opening and/or closing of window 100 via rotation about hinge 140.

Having thus described exemplary embodiments of the present invention, it should be noted by those skilled in the art that the within disclosures are exemplary only and that various other alternatives, adaptations, and modifications may be made within the scope and spirit of the present invention. For example, as an alternative, more than or fewer than two operable sashes may be provided, and one or more of such operable sashes may be arranged in a horizontal track, or the like. Additionally, while the frame of the window has been described and illustrated as swinging inwardly about a top edge thereof, the frame may swing outwardly, and/or may swing about a side or the bottom thereof, or the like. Accordingly, the present invention is not limited to the specific embodiments as illustrated herein.

What is claimed is at least:

1. A window operable with a structure having an opening therein, said window comprising:
a frame having at least one operable sash;
a hinge adapted to allow said frame to move between an open position and a closed position; and
a lift assist device adapted to facilitate movement of said frame between said open position and said closed position and operable to substantially retain said window in said open position,
wherein said frame is disposed substantially covering an opening of a structure in said closed position, and wherein the opening is substantially uncovered when said frame is disposed in said open position.

2. The window of claim 1, wherein said frame includes at least two channels, each of said at least two channels adapted to receive a respective sash.

3. The window of claim 1, wherein said hinge is disposed along a top edge of said frame, and wherein said hinge is operable to allow rotation of said frame about said top edge.

4. The window of claim 1, wherein said lift assist device comprises a pneumatic cylinder and piston operable with said frame and a perimeter of the opening to apply a lifting force therebetween.

5. The window of claim 1, wherein said frame is disposed substantially parallel with a portion of the structure in which the opening is formed when said frame is disposed in said closed position, and wherein said frame is disposed generally perpendicular to the portion of the structure in which the opening is formed when said frame is disposed in said open position.

6. A method of ventilating a structure, the structure having a window operable with an opening of the structure, the method comprising the steps of:
uncovering a portion of the opening by at least one sash of the window, the portion of the opening being substantially less than the entire opening; and
uncovering substantially the entire opening by rotating a frame of the window about a hinge to an open position.

7. The method of claim 6, wherein said step of uncovering substantially the entire opening comprises rotating the frame about a hinge operable with a top of the frame, whereby the bottom of the frame swings inwardly and upwardly.

8. The method of claim 7, wherein said frame swings inwardly and upwardly assisted by a pneumatic piston.

9. The method of claim 6, further comprising the step of automatically retaining the frame in the open position.
